(19) United States
(12) Patent Application Publication
(10) Pub. No.: US 2007/0239536 A1
(43) Pub. Date: Oct. 11, 2007

(54) System and method for scheduling audience deficiency units and makegoods

(75) Inventor: Srinivas Bollapragada, Niskayuha, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/397,108

(22) Filed: Apr. 5, 2006

(51) Int. Cl. G06Q 30/00

(52) U.S. Cl. 705/14

(57) ABSTRACT

A technique is provided for scheduling audience deficiency units. The technique includes computing delivery shortfalls of promised impressions for an advertising contract and automatically determining and scheduling audience deficiency units to account for the delivery shortfalls.

### BACKGROUND

The invention relates generally to advertising and more particularly to systems and methods for automatically scheduling audience deficiency units and/or makegoods.

Generally, broadcast television networks price and sell advertising time or slots based on the number of audience impressions that they deliver or expect to deliver. Advertisers pay a negotiated cost per thousand (CPM) viewers for the audience demographic they are interested in reaching. The amount that an advertiser pays is the product of the negotiated CPM and the total number of viewers that are expected to watch all the commercials that the network airs for the client. Therefore the higher the number of viewers, the larger is the contract price. However, if the network delivers more viewers than promised on a sales contract, it does not get paid for the additional audience delivery. To ensure that there is no over delivery of audience impressions and to maximize contract price, broadcast networks generally promise more audience impressions than they expect to deliver on their advertising sales contracts. Thus, such over delivery seldom occurs in practice, since TV networks use inflated ratings forecasts when selling their shows. The clients generally agree to the higher ratings forecasts, since the networks guarantee the number of impressions that are delivered on the contracts. On all the contracts that are guaranteed on impressions delivered, if the promised impressions are not delivered, the network airs additional units of commercials, called Audience Deficiency Units (ADUs), for the client to make up for the difference. Generally, a network needs to air about an additional 10% of the units on a typical contract as ADUs. In addition to supplying units for under delivery on contracts, ADUs also help broadcast networks use up inventory on low demand shows and time periods that cannot be easily sold.

Conventionally, the shortfall in delivering promised impression is estimated using rating forecasts and the realized actual rating. The sales personnel then plan the ADUs that need to be aired for each and every contract for the entire broadcast season to cover this shortfall in impressions. However, broadcast networks currently do not develop detailed ADU plans for the year at the start of the season. This is because currently ADU plans are done manually for each contract and it is cumbersome to plan for the entire year. The makegoods/ADU units are manually picked and assigned to each contract by the sales personnel. After they are reviewed by management, they are faxed to the agencies for approval. Any changes negotiated by the agencies are then manually reentered into the system. This manual process is time consuming and cumbersome. Moreover, since clients need to approve the ADU units before they can be finalized, to avoid multiple changes, the sales personnel schedule ADUs and get client approvals a few units at a time closer to the airdates. This results in suboptimal ADU plans. Additionally, the manual process may sometimes result in over delivery on audience impressions and price than required by the contracts. Further, premium inventory that could be sold at a high price throughout the season may end up being assigned to ADUs. Thus, the manual process may lead to suboptimal management of valuable airtime inventory.

It is therefore desirable to provide techniques for automatically scheduling the ADUs and/or makegoods so as to effciently use the airtime inventory and to minimize back office operations.

### SUMMARY

Briefly, in accordance with one aspect of the invention, a method is provided for scheduling audience deficiency units. The method provides for computing delivery shortfalls of promised impressions for an advertising contract and automatically determining and scheduling audience deficiency units to account for the delivery shortfalls. Systems and computer programs that afford functionality of the type defined by this method may also be provided by the invention.

In accordance with another aspect of the invention, a method is provided for scheduling audience deficiency units. The method provides for automatically determining audience deficiency units for an advertising contract by periodically computing a difference between promised impressions and actual impressions delivered or expected to be delivered and automatically placing the audience deficiency units to ensure delivery of the promised impressions. Systems and computer programs that afford functionality of the type defined by this method may also be provided by the invention.

These and other advantages and features will be more readily understood from the following detailed description of preferred embodiments of the invention that is provided in connection with the accompanying drawings.

### BRIEF DESCRIPTION OF THE DRAWINGS

FIG. 1 is a block diagram of a conventional up-front sales process.

FIG. 2 is a block diagram of the sales process of FIG. 1 in greater detail.

FIG. 3 is a block diagram of an initial integer solution for optimally scheduling audience deficiency units and/or makegoods in accordance with aspects of the invention.

FIG. 4 is a block diagram of a search algorithm for improving the initial integer solution of FIG. 3 in accordance with aspects of the invention.

### DETAILED DESCRIPTION OF EXEMPLARY EMBODIMENTS

Exemplary embodiments of the invention are generally directed to automatically scheduling audience deficiency units and/or makegoods via an optimization algorithm. Such systems and methods may be useful in a variety of advertising contexts. While embodiments of the invention are described with specific reference to television advertising, one of ordinary skill in the art will readily apprehend the application of these systems and methods in advertising via other media is well within the scope of the invention.

The broadcast networks generally announce their programming schedules for the new broadcast year a few months in advance. For example, the television broadcast year in the United States starts in the third week of September and the broadcast networks announce their programming schedules in the middle of May. Shortly thereafter, the sale of air-time inventory (advertising slots) begins. The broadcast networks sell about 60 to 80 percent of their air-time inventory during a brief period lasting two to three weeks starting from the date of announcement of the programming schedule as will be described in greater detail below. This sales period is known as the upfront market.

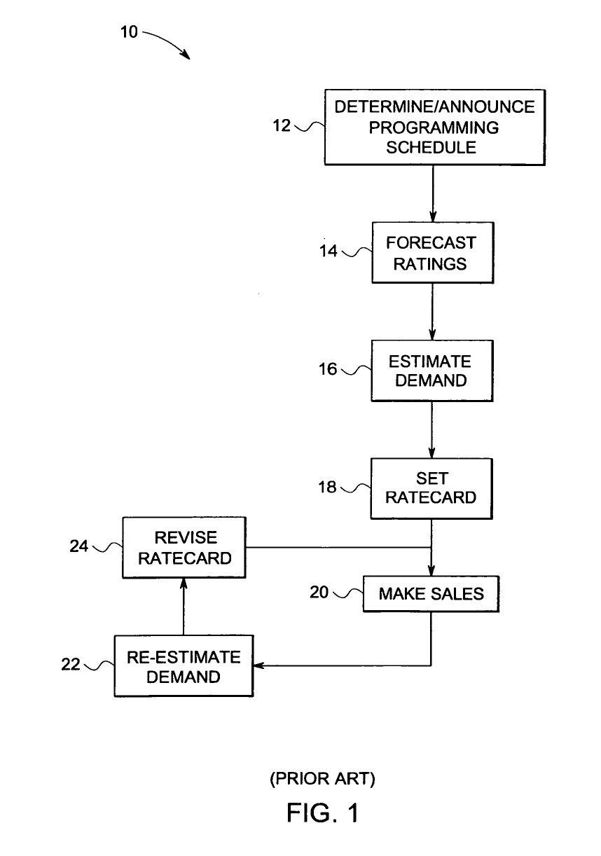

Referring now to FIG. 1, a known upfront sales process 10 begins with the announcement of the program schedule at step 12. Immediately after announcing their program schedules at step 12, the broadcast networks finalize their ratings forecasts at step 14 and estimate the market demand at step 16. The ratings forecasts are projections of the number of people in each of several demographic groups that are expected to watch each airing of the shows in the program schedule for the entire broadcast year. The ratings estimates are based on several factors, such as the strength of the show, historical ratings data for the time slot, the competing shows on other networks, and the performance of the adjacent shows. Typically, broadcast networks develop two sets of ratings forecasts. The first set of forecasts is an optimistic estimate that is used for selling. These forecasts generally over estimate the ratings sometimes by as much as 10%. The other set of estimates called the make good or ADU ratings estimates more accurately forecast the ratings. Once the broadcast networks finalize their ratings projections at step 14 and market demand estimates at step 16, they set the rate cards that contain the prices for commercials on all their shows and develop pricing strategies at step 18. The process 10 completes with the sale of air-time inventory at step 20. It should be noted that, throughout the sale of air-time inventory at step 20, the broadcast networks periodically re-estimate demands at step 22 and adjust the rate cards and pricing strategies at step 24.

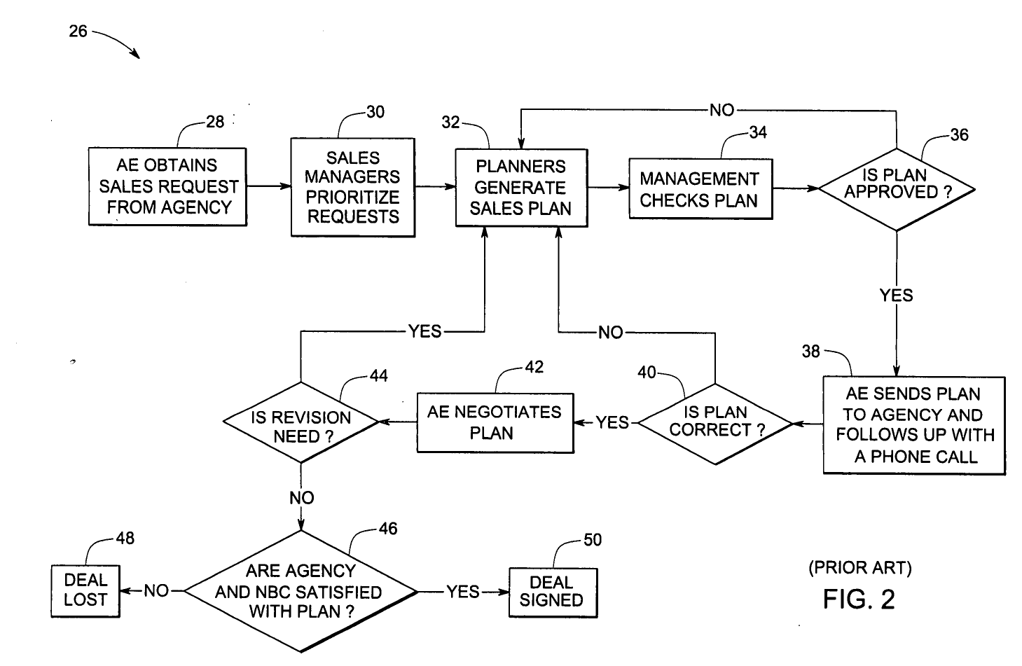

FIG. 2 illustrates a known process 26 for sale of air-time inventory in greater detail. During the up-front market, advertising agencies approach account executives (AEs) with sales requests to purchase time for their clients for the entire season at step 28. A typical request consists of the dollar amount, the demographic (for example, adults between 18 and 49 years of age) in which the client is interested, the program mix, weekly weighting, unit-length distribution, and a negotiated cost per thousand viewers (CPM). Once an AE receives the sales request, the sales managers prioritize the request for generating sales plan at step 30 and forward it to a planner who generates the sales plan at step 32. The planners then develop a detailed sales plan consisting of the schedule of commercials to be aired so as to meet the requirements. In addition, the plan should also meet the objectives of sales management, whose goal is to maximize the revenues for the available fixed amount of the air-time inventory. The sales management then checks the plan to ensure that it meets all of the requirements at step 34. Management tries to ensure that the plan does not give more high-premium inventory to the client than is necessary to win the contract. The plan is prepared to meet an overall budget target specified by the client. The network may attempt to minimize the amount of premium inventory it includes in any given plan. If management does not approve the plan at step 36, it sends it back to the planning department for revisions at step 32. Once the plan is approved internally at step 36, the AE sends it to the agency and follows up with a phone call at step 38. The agency may check the plan to ensure that it does not meet all its requirements at step 40. If the plan is rejected, the AE asks the planner for revisions at step 32. If the plan is accepted, AE negotiates the plan with the agency at step 42. If any further revision is needed at step 44 based on the negotiations, the plan is sent for revisions at step 32. If no further revision is needed at step 44, the agency and the TV network check if they are satisfied with the proposal at step 46. If they reach an agreement, they sign a deal and the plan is converted to a sales contract at step 48. If they cannot reach an agreement, the deal is lost at step 50. It should be noted that, almost all of the sales contracts signed during the upfront market are guaranteed on audience impressions. The CPM is a key metric on the contract.

After the completion of the upfront market, TV networks estimate the number of additional impressions to be delivered on each of the contracts using the difference between promised impressions and the impressions estimated using the ADU ratings forecasts. As the shows air during the broadcast season, the ADU requirements are re-estimated periodically using the actual Nielsen ratings that are realized. In other words, realized audience ratings are used for shows that have aired and rating forecasts are used for future shows to calculate the actual and potential deficiencies on the contract. An algorithm may be executed, in accordance with certain aspects of the invention, to automatically obtain an enhanced placement of makegoods units to meet the requirement for the entire broadcast season.

The algorithm generates ADUs on a contract to meet the requirements specified by the sales personnel. The most important requirement is meeting the audience impressions shortfall while achieving a certain specified rate card CPM (cost per thousand viewers) for the total ADU units on a contract. The ADU CPM on a contract is computed as the ratio of the sum of the rate card dollars for all the ADU units to the sum of the audience impressions (in the guaranteed audience demographic) for all the ADU units on the contract. The ADU-plan should meet an overall rate card CPM and different rate card CPMs by quarter. In addition, when generating the ADU plan, certain other requirements, which are similar to those on the sales plan request, must be met. These requirements include the show-mix, weekly weighting, and unit mix constraints that the ADU planner may specify. The ADU-planner may choose the shows in the program schedule to include in the plan and the fraction of the total number of commercials in the schedule to be included on each show. These requirements are normally specified as fractions of the total number of equivalent 30-second commercials in the plan. In addition, the planner may also specify how the commercials in the schedule are distributed by week in each quarter. The plan may include commercials of varying lengths based on the unit lengths included in the contract. When there are multiple unit lengths in a contract, the planner normally specifies the percentage of ADU commercials of each length. The ADU-plans for all the contracts should be developed simultaneously to meet the contract specific requirements while minimizing the amount of premium inventory used. The goal is to develop an algorithm and a system to minimize the time it took to generate the ADU plans, to improve accuracy in meeting requirements and to minimize the amount of premium inventory assigned to a plan.

The ADU-planning problem is formulated as a goal program. It is desirable for a network to use as little premium inventory as possible in meeting the ADU requirements. Not all inventories are equally valuable. Certain popular shows are in very high demand. Similarly certain weeks in the year, especially during the sweeps periods, are highly desired by the advertisers. To quantify the value of inventory on show s in week w, we define parameters R_{sw}. Management ranks the shows and weeks in the year by their importance. The parameters R_{sw} are calculated using these rankings and the availability of inventory during various weeks. Any premium inventory saved can be used to attract additional high paying customers in the scatter market. As will be appreciated by one skilled in the art, inventory not sold in the upfront market or which becomes available for other reasons, is sold throughout the season in the scatter market. The amount of premium inventory that is used in meeting ADU requirements is therefore minimized.

Further, the ADU requirements may be expressed as goal constraints. Sometimes all the goals cannot be met because of the lack of sufficient inventory. One or more penalty factors may be associated for not meeting the respective goals. The penalties are linearly proportional to the magnitude of deviation from the goals. It should be noted that not all goals are equally important. The penalty factors may be chosen to vary based on the importance of the requirements. The actual penalty factors are determined by trial and error by developing ADU plans under tight inventory constraints, which make it impossible to meet all client requirements. In one embodiment, the total penalty cost incurred on the ADU plan may also be minimized to ensure that all requirements are met when feasible. Thus, the ADU-planning problem may be formulated as follows:

Minimize:
the amount of premium inventory assigned to a ADU plan, and
the total penalty incurred in meeting goals

Subject to:
Inventory constraints:
   Airtime availability constraints, and
   Product conflict constraints;
ADU requirement constraints:
   Ratecard dollars constraints,
   Impressions delivery constraints,
   Show-mix constraints,
   Weekly weighting constraints, and
   Unit-mix constraints.

The decision variables are the numbers of ADUs of each spot length that are to be placed in the shows and weeks included on each contract. The model will be described in greater detail below.

The following notations are used while formulating the problem mathematically:

C=the set of guaranteed contracts on which ADUs have to be placed.

S=the set of all shows.

W=the set of all weeks.

Q=the set of quarters.

K=the set of all product codes for all contracts in C.

Cₖ=the set of all contracts with product code k.

W_{q}^{Q}=the set of all weeks in quarter q.

W=∪_{qεQ}W_{q}^{Q}.

R_{sw}=the rank of show s in week w.

P_{sw}=rate card price for a 30 second commercial on show s in week w.

I_{sw}=number of 30 second equivalent spots available to place ADUs in show s in week w.

X_{ksw}=maximum number of ADUs with product code k that can be aired on show s in week w without violating product conflict constraints.

A_{csw}=number of people in the audience demographic of contract c that are expected to watch show s in week w.

The ADU goals are as follows:

L_{c}=the set of all allowable commercial lengths that can be placed on contract, c. The lengths of the commercials are expressed as multiples of 30-second units.

B_{c}=the total rate-card dollars of all new ADU units to be placed for contract c.

B_{cq}=the total rate card dollars in quarter q for contract c.

α_{cs}=the lower and upper bounds on the fraction of commercials that are to be aired on show s.

β_{cw}=the lower and upper bounds on the fraction of the total impressions in the quarter to be realized in week w.

γ_{cl}=the lower and upper bounds on the fraction of the total units in the plan to be of length l.

As will be appreciated by one skilled in the art, since it may not be possible to meet all the requirements of a client because of inventory constraints, the following slack variables are therefore introduced to measure the deviations in meeting the client requirements:

σ_{cq1}^{B}, σ_{cq2}^{B}=the slack variables associated with the lower and upper bounds on the plan budget in quarter q.

σ_{cs1}^{S}, σ_{cs2}^{S}=the slack variables associated with the lower and upper bounds on the fraction of commercials that are to be aired on show s.

σ_{cw1}^{W}, σ_{cw2}^{W}=the slack variables associated with the lower and upper bounds on the fraction of the total impressions in the quarter to be realized in week w.

σ_{cl1}^{∪}, σ_{cl2}^{∪}=the slack variables associated with the lower and upper bounds on the fraction of the total units on the plan to be of length l.

It should be noted that the slack variables are all non-negative. Further, one or more penalties may be introduced for not meeting the client goals. The penalty incurred in not meeting a goal is proportional to the slack variable associated with that goal constraint. Since it is more important to meet some requirements than others, the penalty parameters are chosen based on the importance of the goals. The penalty parameters used are as follows.

π^{B}=the linear penalty associated with not meeting quarterly budget requirements.

π^{S}=the linear penalty associated with not meeting the show-mix requirements

π^{W}=the linear penalty associated with not meeting the weekly weighting constraints.

π^{∪}=the linear penalty associated with not meeting the unit-mix requirements.

The decision variables are:

x_{swl}=the number of ADU units of length l, on show s in week w assigned to the plan

The following dependent variables may be used to make the problem formulation more readable:

$${b}_{c} = {\sum }_{s ∈ S} {\sum }_{w ∈ W} {\sum }_{l ∈ {L}_{c}} l {P}_{sw} {x}_{cswl} ,$$

the sum of rate card dollars for all ADU units assigned to contract, c.

$${b}_{cq} = {\sum }_{s ∈ S} {\sum }_{w ∈ {W}_{q}} {\sum }_{l ∈ {L}_{c}} l {P}_{sw} {x}_{cswl} ,$$

the total rate-card dollars for all ADU units in quarter q for contract, c.

$${g}_{c} = {\sum }_{s ∈ S} {\sum }_{w ∈ W} {\sum }_{l ∈ {L}_{c}} l {A}_{sw} {x}_{cswl} ,$$

the total audience delivered by the ADU units for contract, C.

$${g}_{cq} = {\sum }_{s ∈ S} {\sum }_{w ∈ {W}_{q}} {\sum }_{l ∈ {L}_{c}} l {A}_{sw} {x}_{cswl} ,$$

the total audience delivered by the ADU units in quarter q for contract, c.

$${u}_{c} = {\sum }_{s ∈ S} {\sum }_{w ∈ W} {\sum }_{l ∈ {L}_{c}} l {x}_{cswl} ,$$

the total 30-second equivalent ADUs units assigned to contract, c.

$${u}_{cq} = {\sum }_{s ∈ S} {\sum }_{w ∈ {W}_{q}} {\sum }_{l ∈ {L}_{c}} l {x}_{cswl} ,$$

the total 30-second equivalent ADUs units assigned to contract, c in quarter q.

A comprehensive mathematical representation of the requirements specified by an ADU-planner and a detailed mathematical formulation of the problem may now be given as follows:
Minimize:

$${\sum }_{s ∈ S} {\sum }_{w ∈ W} {\sum }_{l ∈ L} l {R}_{sw} {x}_{swl} {+ \sum }_{i = 1}^{2} ( {\sum }_{q ∈ Q} {π}^{B} {σ}_{qi}^{B} + {\sum }_{q ∈ Q} {π}^{B} {σ}_{qi}^{B} + {\sum }_{q ∈ Q} {π}^{B} {σ}_{qi}^{B} + {\sum }_{q ∈ Q} {π}^{B} {σ}_{qi}^{B} )$$

Subject to the following constraints:

$$\begin{matrix}{\sum }_{q ∈ Q} {b}_{cq} - {b}_{c} = 0 & ∀ q ∈ Q \\ {\sum }_{q ∈ Q} {g}_{cq} - {g}_{c} = 0 & ∀ q ∈ Q \\ {\sum }_{q ∈ Q} {u}_{cq} - {u}_{c} = 0 & ∀ q ∈ Q \\ {\sum }_{s ∈ S} {\sum }_{w ∈ {W}_{q}} {\sum }_{l ∈ {L}_{c}} l {P}_{sw} {x}_{cswl} - {b}_{cq} = 0 , & ∀ q ∈ Q \\ {\sum }_{s ∈ S} {\sum }_{w ∈ {W}_{q}} {\sum }_{l ∈ {L}_{c}} l {A}_{sw} {x}_{cswl} - {g}_{cq} = 0 , & ∀ q ∈ Q \\ {\sum }_{s ∈ S} {\sum }_{w ∈ {W}_{q}} {\sum }_{l ∈ {L}_{c}} l {x}_{cswl} - {u}_{cq} = 0 , & ∀ q ∈ Q\end{matrix}$$

Budget constraints:

b_{c}≧B_{c1}

b_{c}≦B_{c2}

b_{cq}+σ_{cq1}^{B}−σ_{cq2}^{B}≧B_{cq}, ∀qεQ

Impression constraints:

g_{c}≧G_{c1}

g_{c}≦G_{c2}

g_{cq}+σ_{cq1}^{G}−σ_{cq2}^{G}≧G_{cq}, ∀qεQ

Show-mix constraints:

$$\begin{matrix}{\sum }_{w ∈ W} {\sum }_{l ∈ {L}_{c}} l {x}_{cswl} - {α}_{cs} u + & ∀ s ∈ S , ∀ c ∈ C & \\ {σ}_{cs 1}^{S} - {σ}_{cs 2}^{S} \geq 0 , & & \\ Weekly weighting constraints & & \\ {\sum }_{s ∈ S} {\sum }_{l ∈ {L}_{c}} l {A}_{csw} {x}_{cswl} - & \begin{matrix}∀ w ∈ {W}_{q} , ∀ q ∈ Q , \\ ∀ c ∈ C\end{matrix} & \\ {β}_{cw} {g}_{cq} + {σ}_{cw 1}^{W} - {σ}_{cw 2}^{W} \geq 0 , & & \\ Unit \text{-} mix constraints \text{:} & & \\ \begin{matrix}{\sum }_{s ∈ S} {\sum }_{w ∈ W} l {x}_{cswl} - {γ}_{cl} u + \\ {σ}_{l 1}^{U} - {σ}_{l 2}^{U} \geq 0 ,\end{matrix} & ∀ l ∈ {L}_{c} , ∀ c ∈ C & \\ Inventory constraints \text{:} & & \\ {\sum }_{c ∈ C} {\sum }_{l ∈ {L}_{c}} l {x}_{cswl} \leq {I}_{csw} & \begin{matrix}∀ s ∈ S , ∀ w ∈ W , \\ ∀ c ∈ C\end{matrix} & \begin{matrix}Airline \\ \begin{matrix}availability \\ cts .\end{matrix}\end{matrix} \\ {\sum }_{c ∈ {C}_{k}} {\sum }_{l ∈ {L}_{c}} {x}_{cswl} \leq {X}_{ksw} & \begin{matrix}∀ s ∈ S , ∀ w ∈ W , \\ ∀ k ∈ K\end{matrix} & \begin{matrix}\begin{matrix}Product \\ conflict\end{matrix} \\ constraints .\end{matrix}\end{matrix}$$

The inventory constraints are the hard constraints in the model. The airtime-availability constraints ensure that sufficient inventory is available on a given airing of a show to schedule a commercial for a client. The product-conflict constraints make sure that commercials for two competing products are not aired during the same commercial break. For example, commercials for both Coca-Cola® product and Pepsi® products should not air in the same commercial break.

As will be appreciated by one skilled in the art, the ADU-requirement constraints model the criteria specified by the sales personnel. Because of the discrete nature of the problem, it may be difficult to generate a plan that meets all requirements exactly. For example it may be difficult to allot exactly ten percent of the commercial slots on a particular show to an ADU plan while meeting all other requirements. However, it should be noted that it is sufficient to meet these requirements within a certain range. When users ask that 10 percent of commercials be on a certain show, they generally accept a percentage between 9.7 and 10.3 percent. The ranges of the allowed intervals vary with the requirement types. The ADU planner is allowed to control the widths of these intervals from the user interface.

In certain situations, it may still be difficult to meet the requirements within these intervals because of insufficient inventory. One or more non-negative slack variables are therefore associated with each of these constraints. Further, one or more linear penalty costs may be associated with the respective slack variables to ensure that the requirements are always met when feasible. As noted above, not all requirements are equally important. The magnitudes of the penalty costs are therefore chosen to vary to reflect this.

It is desirable to meet the client's requirements in a manner that allows for the best use of airtime inventory. The objective function includes a term, which represents the total value of inventory used as measured using the parameters R_{sw}. The objective function also includes terms that measure the penalties incurred in not meeting the user-entered requirements.

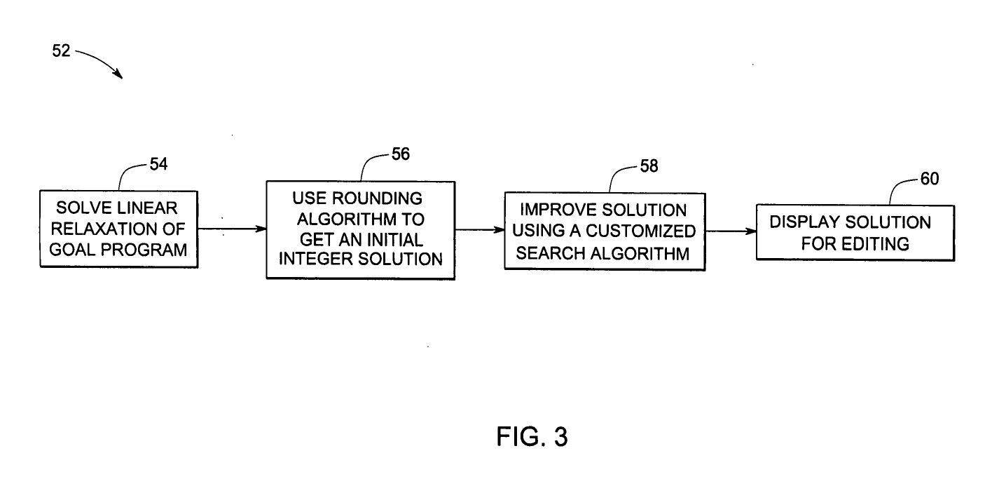

The goal-programming formulation discussed above results in an integer program that is too large to solve in a reasonable amount of time using existing math program solvers such as CPLEX. A customized algorithm 52 for solving the problem is therefore developed as illustrated in FIG. 3. The algorithm 52 involves solving the linear relaxation of the goal program at step 54 and intelligently rounding the solution to get an initial approximate integer solution at step 56. In the illustrated algorithm 52, using the data entered by the user, a linear program may be formulated that is a linear relaxation of the goal program at step 54. The linear program is then solved using the CPLEX linear program solver at step 54. The results are rounded using a heuristic-rounding algorithm at step 56 as described below.

In the rounding algorithm, the variables are sorted in a descending order of the size of their fractional parts in the linear programming solution. The starting integer solution is obtained by truncating the variables. The variables that had nonzero fractional values in the linear program solution are reevaluated one at time in the sorted order, deciding whether to increment the value of a variable by one. A variable is incremented if doing so does not violate any of the upper bounds on client requirements else it is not incremented. The initial integer solution thus obtained from rounding the solution of the linear relaxation at step 56 is further improved using a customized search algorithm at step 58 as will be described in greater detail below. The final solution is then displayed for review and editing at step 60.

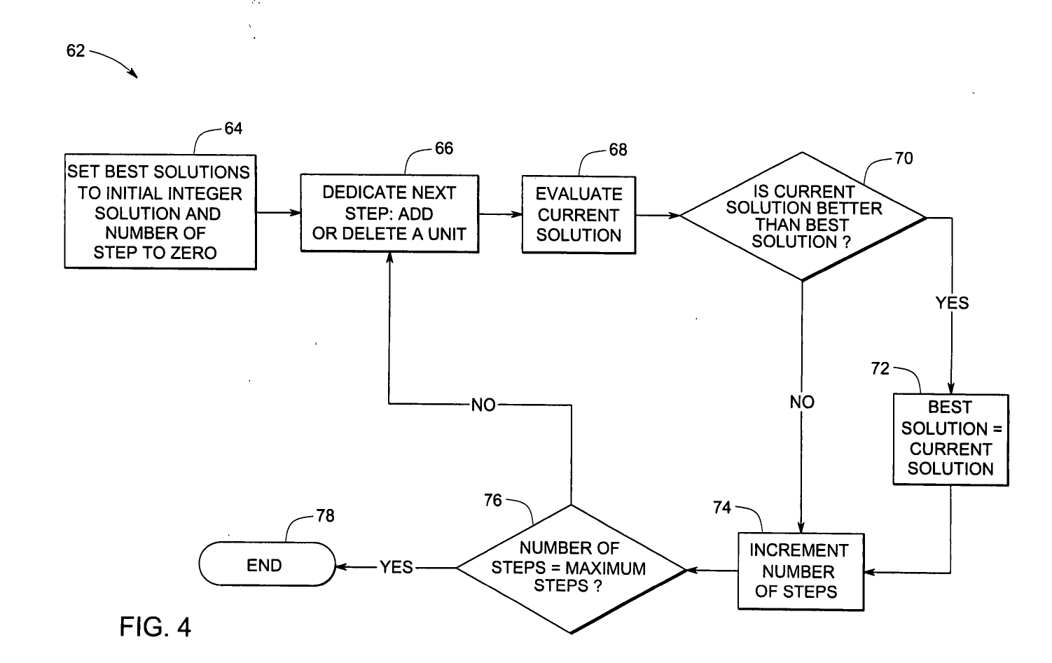

FIG. 4 illustrates a customized search algorithm 62 used in step 58 (FIG. 3) to improve the initial integer solution obtained at step 56. The search algorithm 62 explores the feasible region while maintaining and updating a list of recent steps and remembering the best solution obtained thus far. The algorithm searches through the solution space by taking one step at a time. The algorithm 62 begins by assigning the initial integer solution as the best solution and the number of step to zero at step 64. At each step a decision is made whether to add or delete a single unit in a show airing included in the plan at step 66. The resulting plan is evaluated at step 68. The resulting solution is then compared with the best solution on hand at step 70. If the current solution is better than the best solution, the best solution is replaced with the current one at step 72 and the number of iteration is incremented by one at step 74. If the current solution is not better than the best solution, the number of iteration is incremented by one at step 74. If the total number of iteration is less than the maximum allowed iterations at step 76 the complete process is repeated else the process ends at step 78. The algorithm maintains a list of the most recent steps taken in a list of fixed length. This list is used to ensure that a step that was recently taken is not reversed. The process is repeated for a fixed number of steps. The best solution on record is then used as the final solution. Once the system comes up with a plan, it is displayed to the user to make any changes.

In operation, the ADU placement algorithm is executed at a fixed interval (for example, every night) in a batch mode to place the ADU units. The ADU placement algorithm begins by computing the ADU impressions that need to be delivered by contract. It then deletes all the existing ADU units that have not been locked by the users and re-compute all the units.

As will be appreciated by one skilled in the art, the ADU placement algorithm as described in the various embodiments discussed above provides automatic and optimal placement of makegood/ADU units to ensure that we do not over deliver on our audience and price requirements, and make the best possible use of makegood inventory in meeting our requirements. This leads to increase in revenues through optimal ADU inventory management. For example, NBC TV network uses nearly half a billion dollars worth of makegoods inventory to meet its audience deficiency requirements. Managing this inventory optimally leads to significant savings through better utilization of makegoods inventory. Additionally, automatically generating the makegood units via the ADU placement algorithm leads to reduction in back office operations.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A method for scheduling audience deficiency units, comprising:
computing delivery shortfalls of promised impressions for an advertising contract; and
automatically determining and scheduling audience deficiency units to account for the delivery shortfalls.

2. The method of claim 1, wherein said computing delivery shortfalls comprises periodically computing a difference between promised impressions and actual impressions delivered or expected to be delivered.

3. The method of claim 2, wherein the actual impressions delivered is based on a realized audience rating and actual impressions expected to be delivered is based on a rating forecast.

4. The method of claim 2, wherein the actual impressions expected to be delivered is re-estimated periodically based on the actual ratings that are realized.

5. The method of claim 1, wherein said automatically determining and scheduling audience deficiency units comprises meeting one or more contract specific requirements while minimizing the amount of premium inventory used.

6. The method of claim 5, wherein the one or more contract specific requirements comprises at least one of inventory constraints and audience deficiency unit requirement constraints.

7. The method of claim 6, wherein the inventory constraints includes airtime availability constraints, product conflict constraints or a combination thereof.

8. The method of claim 6, wherein the audience deficiency unit requirement constraints includes ratecard dollar constraints, impressions delivery constraints, show-mix constraints, weekly weighting constraints, unit-mix constraints, or a combination thereof.

9. The method of claim 5, wherein the one or more contract specific requirements are specified by an ADU planner or a sales personnel.

10. The method of claim 5, further comprising associating respective penalty factors for failing to meet corresponding contract specific requirements.

11. The method of claim 5, wherein said minimizing the amount of premium inventory used comprises minimizing a total penalty incurred in meeting the one or more contract specific requirements.

12. A method for scheduling audience deficiency units, comprising:
automatically determining audience deficiency units for an advertising contract by periodically computing a difference between promised impressions and actual impressions delivered or expected to be delivered; and
automatically placing the audience deficiency units to ensure delivery of the promised impressions.

13. The method of claim 12, wherein the actual impressions delivered is based on a realized audience rating and actual impressions expected to be delivered is based on a rating forecast.

14. The method of claim 12, wherein the actual impressions expected to be delivered is re-estimated periodically based on the actual ratings that are realized.

15. The method of claim 12, wherein said automatically placing comprises automatically placing the audience deficiency units via an algorithm configured for meeting one or more contract specific requirements while minimizing the amount of premium inventory used.

16. The method of claim 15, wherein the one or more contract specific requirements comprises at least one of inventory constraints and audience deficiency unit requirement constraints.

17. The method of claim 15, further comprising associating respective penalty factors for failing to meet corresponding contract specific requirements.

18. The method of claim 15, wherein said minimizing the amount of premium inventory used comprises minimizing a total penalty incurred in meeting the one or more contract specific requirements.

19. A system for scheduling audience deficiency units, comprising:
a processor configured to compute shortfalls in delivering promised impressions for an advertising contract, and to automatically determine and schedule audience deficiency units via an algorithm to account for the shortfalls.

20. The system of claim 19, wherein the processor is configured to compute shortfalls in delivering promised impressions by periodically computing a difference between promised impressions and actual impressions delivered or expected to be delivered.

21. The system of claim 19, wherein the processor is configured to automatically determine and schedule audience deficiency units by meeting one or more contract specific requirements while minimizing the amount of premium inventory used.

22. A computer readable media, comprising:
routines for computing shortfalls in delivering promised impressions for an advertising contract; and
routines for determining and scheduling audience deficiency units via an algorithm to account for the shortfalls.

23. The computer readable media of claim 22, wherein routines for computing shortfalls in delivering promised impressions comprises routines for periodically computing a difference between promised impressions and actual impressions delivered or expected to be delivered.

24. The computer readable media of claim 22, wherein routines for determining and scheduling audience deficiency units comprises routines for meeting one or more contract specific requirements while minimizing the amount of premium inventory used.
